(19) United States
(12) Patent Application Publication
(10) Pub. No.: US 2024/0216200 A1
(43) Pub. Date: Jul. 4, 2024

(54) DEVICES, SYSTEMS, AND METHODS FOR STOPPING A CARRIAGE WITHIN A RAIL

(71) Applicant: Liko Research & Development AB, Luleå (SE)

(72) Inventor: Marcus Linde, Luleå (SE)

(73) Assignee: Liko Research & Development AB, Luleå (SE)

(21) Appl. No.: 18/403,319

(22) Filed: Jan. 3, 2024

Related U.S. Application Data
(60) Provisional application No. 63/478,239, filed on Jan. 3, 2023.

(51) Int. Cl. A61G 7/10

(52) U.S. Cl. CPC A61G 7/1042; A61G 7/1051; A61G 2203/12

(57) ABSTRACT

An overhead lift system includes a rail having at least one wall that defines an inner channel shaped and sized to guide movement of a carriage within the inner channel. The at least one wall further defines a longitudinal opening into the inner channel. The longitudinal opening extends along a length of the rail and having a width. The overhead lift system further includes a carriage end stop having a body shaped and sized to correspond to the inner channel such that the body is insertable within the inner channel, and a securement device securably tensioning the carriage end stop against the at least one wall of the rail to prevent movement of the carriage end stop within the inner channel.

### CROSS REFERENCE TO RELATED APPLICATION

The present application claims the priority benefit of U.S. Provisional Patent Application Ser. No. 63/478,239, entitled “DEVICES, SYSTEMS, AND METHODS FOR STOPPING A CARRIAGE WITHIN A RAIL” and filed Jan. 3, 2023, the entire contents of which is incorporated herein in its entirety.

### BACKGROUND

### Field

The present disclosure relates to overhead lift systems, and more specifically, to components for controlling movement of a carriage in an overhead lift system.

### Technical Background

Overhead lifting devices, or lift units, such as patient lifts used in the health care industry, may generally be coupled to an overhead rail system with a carriage which facilitates positioning the overhead lift unit along the length of the rail. Rail end stops are used to ensure the carriage cannot roll out each end of the rail. In conventional systems, a bolt may be placed between the sides of the rail such that the bolt goes across the rail. Such a setup requires access to the sides of the rail in order to install, service, or remove the bolt. In some environments, the rail may be embedded within a ceiling such that only the opening of the bottom of the rail is exposed below the ceiling. In this situation, to install, remove, or service the bolt end stop, a user would be required to remove a portion of the ceiling to access the sides of the rail. In some cases, removal of the ceiling may be difficult to achieve and/or may result in destruction of property.

### SUMMARY

In one aspect, an overhead lift system includes a rail having at least one wall that defines an inner channel shaped and sized to guide movement of a carriage within the inner channel. The at least one wall further includes a longitudinal opening extending along the rail and having a width. The carriage end has a body shaped and sized to correspond to the inner channel such that the body is insertable within the inner channel, and a securement device securably tensions the carriage end stop against a wall of the rail to prevent movement of the carriage end stop within the inner channel.

In another aspect, a device for an overhead lift system includes a carriage end stop including a body shaped and sized to correspond to an inner channel of a such that the body is insertable within the inner channel of the rail and movable in a longitudinal direction along the inner channel of the rail, wherein a first dimension of the body is less than a width of a longitudinal opening of the rail and a second dimension of the body is greater than the width of the longitudinal opening of the rail, and a securement device is coupled to the body extending and from the body, where the securement device is moveable to force the body against an inner surface of the rail and hold the body in place within the channel of the rail.

In yet another aspect, a kit of parts includes the carriage end stop and rail and one or more instructions for inserting the carriage end stop and tensioning the end stop within the rail.

In yet another aspect, a method for installing a device for stopping a carriage inside of a rail includes the steps of inserting a carriage end stop into an inner channel of the rail via a longitudinal opening in the wall of the rail where the carriage end stop is sized to correspond to the inner channel, and tensioning the carriage end stop against the inner channel of the rail using a security device.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an illustrative overhead lift system including an overhead lift unit, according to one or more embodiments shown and described herein;

FIG. 2 schematically depicts a perspective view of an illustrative carriage end stop disposed in a rail of an overhead lift system according to one or more embodiments shown and described herein;

FIG. 3 schematically depicts a front view of the carriage end stop disposed in the rail of FIG. 2 according to one or more embodiments shown and described herein;

FIG. 4A schematically depicts a method of first orientation of the carriage end stop of FIG. 3 relative to the rail according to one or more embodiments shown and described herein;

FIG. 4B schematically depicts a method of second orientation of the carriage end stop of FIG. 3 relative to the rail according to one or more embodiments shown and described herein;

FIG. 4C schematically depicts a method of third orientation of the carriage end stop of FIG. 3 relative to the rail according to one or more embodiments shown and described herein;

FIG. 5A schematically depicts the method of first orientation of the carriage end stop of FIG. 4A in a perspective cutaway view of the rail according to one or more embodiments shown and described herein;

FIG. 5B schematically depicts the method of second orientation of the carriage end stop of FIG. 4B in a perspective cutaway view of the rail according to one or more embodiments shown and described herein;

FIG. 5C schematically depicts the method of third orientation of the carriage end stop of FIG. 4C in a perspective cutaway view of the rail according to one or more embodiments shown and described herein;

FIG. 6 schematically depicts the carriage end stop of FIG. 2 rotated relative to the rail, showing a width of the end stop being wider than a width of the longitudinal opening of the rail according to one or more embodiments shown and described herein;

FIG. 7 schematically depicts the carriage end stop wherein a portion of the carriage end stop is placed between the portions of the rail forming the longitudinal opening according to one or more embodiments shown and described herein;

FIG. 8 schematically depicts an illustrative carriage end stop and an illustrative securement device according to one or more embodiments shown and described herein;

FIG. 9 schematically depicts a side view of an illustrative wall of a rail having a plurality of indentations therein according to one or more embodiments shown and described herein;

FIG. 10 schematically depicts a side view of an illustrative carriage end stop having a bumper disposed on a surface thereof according to one or more embodiments shown and described herein;

FIG. 11 schematically a side view of an illustrative carriage end stop having a gripping surface disposed on a bottom face of the carriage end stop according to one or more embodiments shown and described herein;

FIG. 12 schematically depicts a front view of the carriage end stop disposed in the rail of FIG. 2, wherein the securement device is a threaded bolt and the carriage end stop includes a threaded bore according to one or more embodiments shown and described herein;

FIG. 13 schematically depicts a front view of a rail and carriage with a carriage end stop installed in the rail, wherein the securement device has a tapered end according to one or more embodiments shown and described herein;

FIG. 14 schematically depicts the front view of the carriage end stop disposed in the rail of FIG. 2, wherein the rail is embedded within a ceiling of a facility according to one or more embodiments shown and described herein;

FIG. 15 depicts a flow diagram of an illustrative method for securing a carriage end stop within a rail according to one or more embodiments shown and described herein;

FIG. 16 depicts a flow diagram of another illustrative method for securing a carriage end stop within a rail according to one or more embodiments shown and described herein; and

FIG. 17 depicts a flow diagram of yet another method of securing a carriage end stop within a rail according to one or more embodiments shown and described herein.

### DETAILED DESCRIPTION

Embodiments disclosed herein include overhead lift systems and devices and methods for containing travel of a carriage within a rail. Specifically, embodiments described herein include a rail having at least one wall that defines an inner channel. The inner channel is shaped and sized to guide the movement of a carriage within the inner channel. A carriage end stop shaped and sized to correspond to the inner channel such that the body is insertable within the inner channel. The carriage end stop may be securably tensioned to the wall of the rail with a securement device. The carriage end stop may constrain movement of the carriage within the rail. The rail may also include a longitudinal opening with a width. The carriage end stop may be insertable through the longitudinal opening. By inserting the carriage end stop through the longitudinal opening, the carriage end stop may be inserted, removed, and serviced within the rail completely from underneath and without having to access the sides of the rail. In situations where the sides of a rail are obscured such are by ceilings of a facility, the ability to access the carriage end stop from completely underneath the rail allows easier access compared to other carriage end stops which are inserted, serviced, and removed from the sides of a rail.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers only A, only B, only C, or any combination of A, B, and C.

As used in this application, stating that any part is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

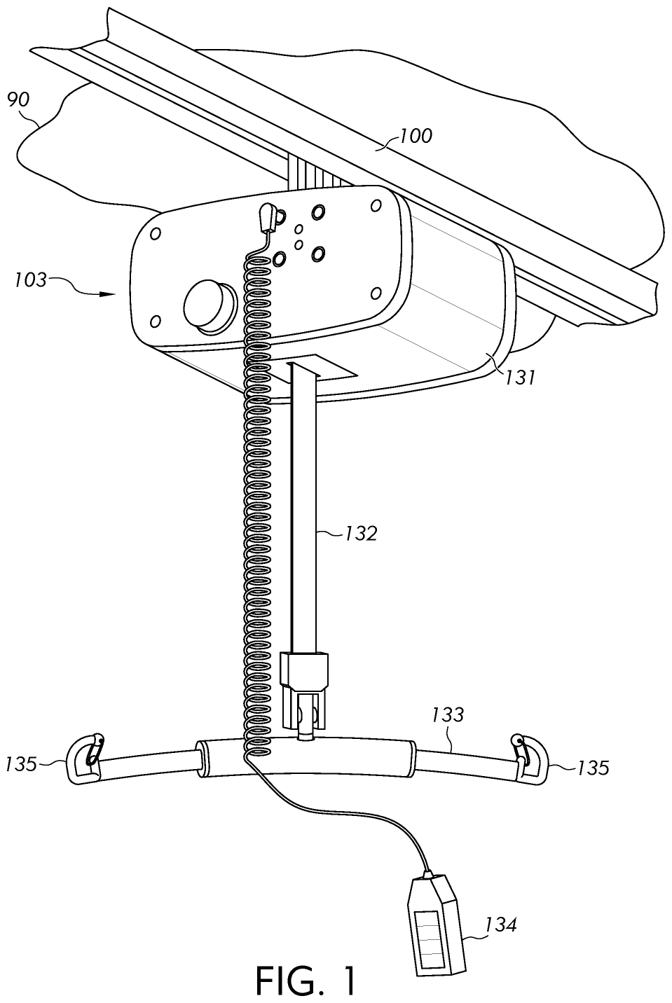

Referring now to FIG. 1, a perspective view of an overhead lift system 90 is shown. The overhead lift system 90 generally includes a lift unit 131 which is slidably coupled to rail 100 (e.g., an overhead rail) with a carriage 103. The carriage 103 generally includes a carriage body 136 (not shown) which includes a plurality of support wheels 137a, 137b, 137c, and 137d (not shown), which are rotatably attached for supporting the carriage 103 within the rail 100. The support wheels 137a, 137b, 137c, and 137d facilitate positioning the carriage 103 and the lift unit 131 along the length of the rail. In the embodiments described herein, the carriage 103 is described with four support wheels. However, it is contemplated that the carriage 103 may be constructed with fewer than four support wheels. For example, the carriage 103 may be constructed with two support wheels (e.g., a pair of support wheels). In some embodiments, the carriage 103 may be constructed with more than four support wheels. The lift unit 131 may be used to support and/or lift a subject with a lifting strap 132 which is coupled to a motor (not shown) contained within the lift unit 131. The motor facilitates paying-out or taking-up the lifting strap 132 from the lift unit 131 thereby raising and lowering a subject attached to the lifting strap 132. In the embodiments described herein, the lift unit 131 further includes a battery which is housed in the lift unit 131 and electrically coupled to the motor thereby providing power to the motor. However, it should be understood that, in other embodiments, the lift unit 131 may be constructed without the battery, such as when the motor is directly coupled to a power source.

In the embodiment of the overhead lift system 90 shown in FIG. 1, a subject may be attached to the lifting strap 132 with a sling bar 133 or a similar accessory attached to the lifting strap 132. More specifically, the sling bar 133 or a similar accessory may be attached to a harness or sling in which the subject is positioned thereby facilitating the lifting operation. The lift unit 131 may be actuated with a user input device 134 which is communicatively coupled to the motor. In the embodiment shown in FIG. 1, the user input device 134 is directly wired to the lift unit 131. However, it should be understood that, in other embodiments, the user input device 134 may be wirelessly coupled to the lift unit 131 to facilitate remote actuation of the lift unit 131.

In various embodiments, the lifting strap 132 is configured to be extended and retracted by the lift unit 131. The sling bar 133 is coupled to an end of the lifting strap 132 through a connector. The lift unit 131 may further include a motor and a drum (not shown), each positioned within a housing of the lift unit 131. The drum may be coupled to a shaft of the motor and the motor may be configured to extend and retract the lifting strap 132 as the motor rotates the drum in response to a user providing an input to the control system via the user input device 134. Various lift units may be employed, including those described in U.S. Patent Application Publication No. 2015/0216753, entitled “Person Lift System,” which is hereby incorporated by reference in its entirety. Suitable commercially available lift units include, by way of example and not limitation, lift systems available under the trade names GOLVO®, LIKO®, SABINA®, VIKING®, UNO™, LIKOGUARD™, LIKORALL™, and MULTIRALL™, from Liko, HILL-ROM®, or Hill-Rom Services, Inc. (Batesville, Ind.).

In various embodiments, such as the embodiment depicted in FIG. 1, a subject support apparatus may be coupled to the lift unit 131 using the sling bar 133. As shown in FIG. 1, the sling bar 133 includes an elongated bar and two hooks 135 coupled to the distal ends of the elongated bar. In other embodiments, the sling bar 133 may be an X-shaped sling bar that includes two curved frame members coupled by a middle frame member and including four support apparatus coupling mechanisms, or hooks. In still other embodiments, the sling bar may include a U-shaped frame including two support apparatus coupling mechanisms and a U-shaped handle extending from the frame to provide stability to a subject being lifted. Other sling bar configurations are contemplated. Various sling bar configurations are described in greater detail in U.S. Patent Application Publication No. 2015/0216753, entitled “Person Lift System,” which is hereby incorporated by reference in its entirety.

Suitable sling bars include, by way of example and not limitation, those commercially available under the trade names Universal SlingBar, SlingBar Mini, and Sling Cross-Bar, from Liko, HILL-ROM®, or Hill-Rom Services, Inc. (Batesville, Ind.). Additionally, it is contemplated that some embodiments may not include a sling bar.

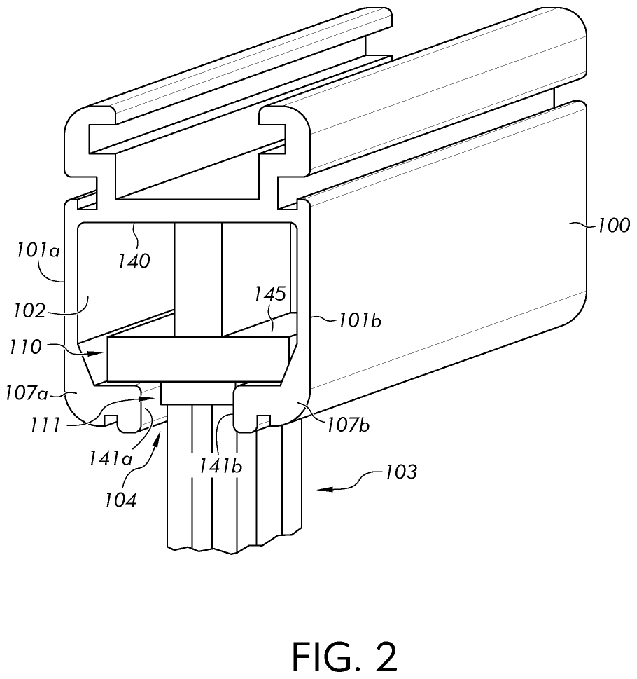

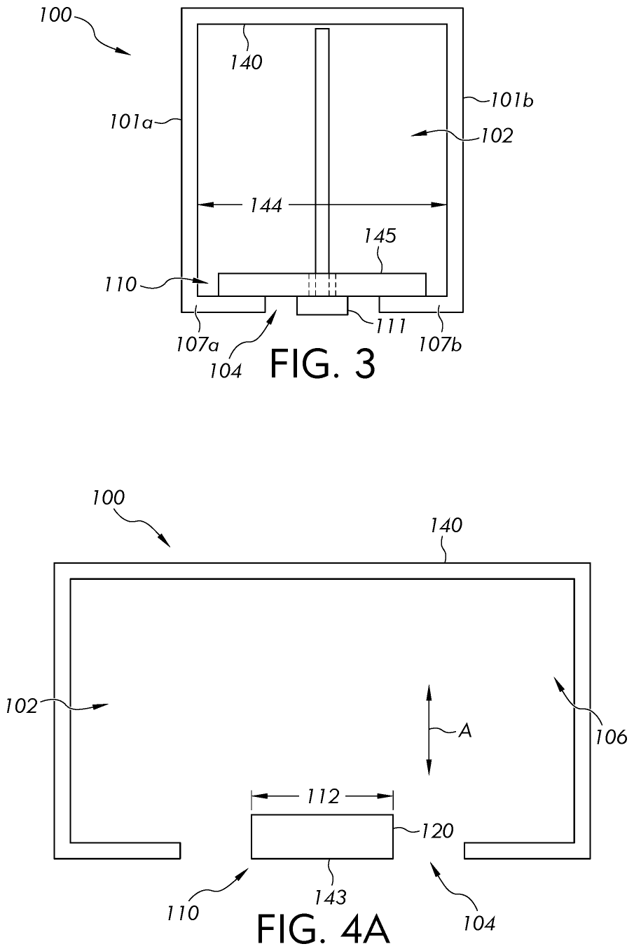

Referring now to FIGS. 2 and 3, an exemplary embodiment of the overhead lift system 90 including a rail 100 and carriage end stop 110 is shown. The overhead lift system 90 further includes a rail 100 in which the carriage 103 is slidably disposed for movement relative to the rail 100. Accordingly, it should be understood that, when the lift unit 131 is mechanically coupled to the carriage 103, the lift unit 131 may be traversed along the rail 100 with the carriage 103. The rail 100 may be formed from a metallic material, such as aluminum, an aluminum alloy, or a similar metallic material, and generally includes an upper wall 140, a first wall 101a integrally formed with the upper wall 140, and a second wall 101b integrally formed with the upper wall 140. The upper wall 140, the first wall 101a, and the second wall 101b of the rail 100 are oriented such that the upper wall 140, the first wall 101a, and the second wall 101b form an inner channel 102 within which the carriage 103 is slidably disposed. To that end, the first wall 101a further includes a first rail support flange 107a which extends from the first wall 101a into the inner channel 102 and the second wall 101b further includes a second rail support flange 107b which extends from the second wall 101b into the inner channel 102. In various embodiments, the first rail support flange 107a and the second rail support flange 107b form the inner channel 102. The carriage end stop 110 may rest on both the first rail support flange 107a and the second rail support flange 107b.

In the embodiments described herein, the first rail support flange 107a and the second rail support flange 107b are generally opposed to one another and lie in a common horizontal plane. Accordingly, when the wheel assemblies are in the expanded position, the wheel assembly including the support wheel 137a (not shown) rides along the first rail support flange 107a and the wheel assembly including the support wheel 137b (not shown) rides along the second rail support flange 107b. The first rail support flange 107a and the second rail support flange 107b define a longitudinal opening 104 in the rail 100 through which the support arms 138a, 138b (not shown) extend when the support wheels 137a, 137b (not shown) are coupled with the rail 100. In various embodiments, when in the retracted position, an outer surface of the wheel assembly including the support wheel 137a and the outer surface of the wheel assembly including the support wheel 137b are separated by a distance less than the width of the opening between the first rail support flange 107a and the second rail support flange 107b, thereby enabling the support wheels to pass through the opening in the retracted position. In various embodiments, the outer surface of each wheel assembly may be a surface of the support wheel separated from the support arm by the thickness of the wheel.

Still referring to FIGS. 2 and 3, the first rail support flange 107a can include a first end face 141a, and second rail support flange 107b can include a second end face 141b. The space between the first end face 141a and second end face 141b forms a longitudinal opening 104. The longitudinal opening 104 allows for items hanging below carriage 103 to travel with the carriage 103 along the rail 100. In addition, the longitudinal opening 104 allows for an end stop to be inserted therein, as described in greater detail herein. The first rail support flange 107a and the second rail support flange 107b may also be substantially parallel with the upper wall 140 of the rail 100. However, it should be understood that other configurations of the support flanges and the upper wall of the rail 100 are also contemplated. For example, in an alternative embodiment, the support flanges may be upwardly angled with respect to the horizontal plane. Moreover, it should be understood that the structure of the rail 100 depicted in the figures is exemplary and that other rail configurations are contemplated. As will be described in greater detail herein, the first rail support flange 107a and the second rail support flange 107b support an end stop within the inner channel 102 when the end stop is inserted through the longitudinal opening 104 and rotated within the inner channel 102.

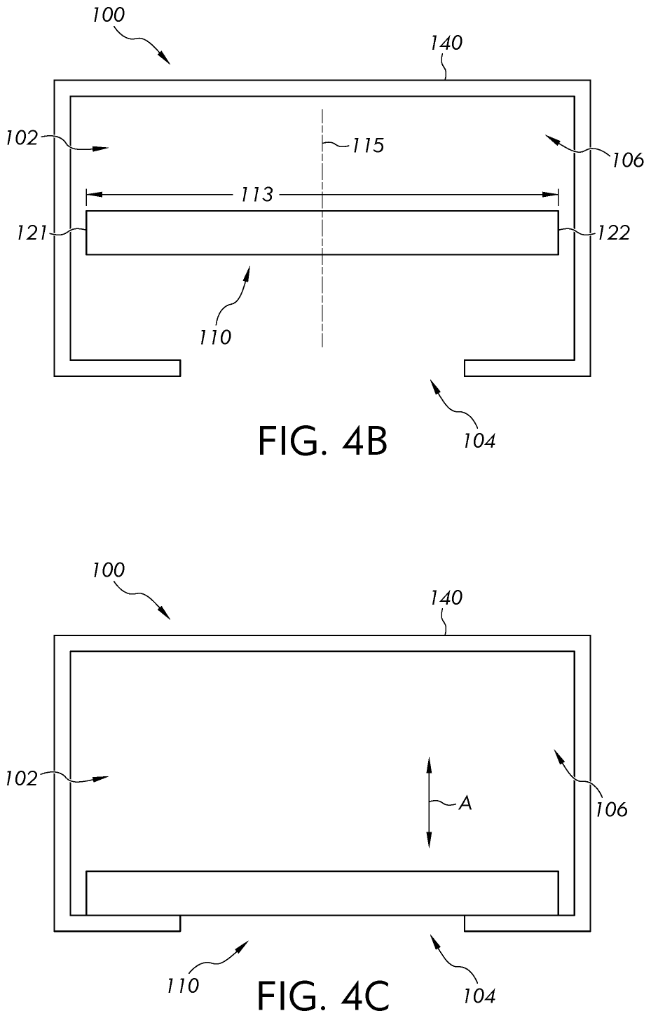

With reference to FIGS. 2-3 and 4A-4C, the carriage end stop 110 has a body 145 having at least a first dimension 113 (see FIG. 4B) and a second dimension 112 (See FIG. 4A). The first dimension 113 of the body 145 generally includes a length that is greater than a length of the second dimension 112 of the body 145 such that the body 145 has a substantially oblong shape. The carriage end stop 110 also includes a lateral surface 120 (see FIG. 4A) that is the end of the carriage end stop 110 that is oriented towards the carriage when the carriage end stop 110 is installed inside the rail 100, as described herein. The carriage end stop 110 also includes a lower face 143 (FIG. 4A) which contacts the first rail support flange 107a and the second rail support flange 107b when the carriage end stop 110 is installed in the rail 100.

The upper wall 140, first wall 101a, second wall 101b, first rail support flange 107a, and second rail support flange 107b of the rail 100 define a inner channel 102. The first wall 101a and the second wall 101b can be separated from one another by a rail width 144. The carriage end stop 110 may be sized to correspond to the inner channel 102 such that the carriage end stop 110 is insertable into the inner channel 102. That is, the second dimension 112 of the body 145 is smaller than a width of the longitudinal opening 104 such that the carriage end stop 110, when oriented with respect to the longitudinal opening 104 is able to pass through the longitudinal opening 104 and into the inner channel 102, as described herein.

The carriage end stop 110 may be held in place by a securement device 111. The securement device 111 may tension the carriage end stop 110 against the first rail support flange 107a and the second rail support flange 107b. The securement device 111 further contacts the upper wall 140 as the securement device 111 tensions the carriage end stop 110.

In other embodiments not illustrated, the carriage end stop 110 may be placed against the upper wall 140 of the rail 100. The securement device 111 may be placed through a hole in the upper wall 140 of the rail 100 such that the securement device 111 tensions the securement device against the upper wall 140 of the rail 100. In some embodiments, there may be a plurality of holes in the upper wall 140 of the rail 100 such that a user may select one hole in the upper wall 140 of the rail 100 into which the securement device 111 can be placed.

Referring now to FIGS. 4A, 4B, and 4C, various methods of orientation of the carriage end stop 110 of FIGS. 2 and 3 are shown. As shown in FIG. 4A, the carriage end stop 110 is oriented in a way so as to allow it to pass through longitudinal opening 104. The carriage end stop 110 may be inserted into the inner channel 102 by moving the carriage end stop 110 toward the upper wall 140 along the direction shown by arrow A.

As shown in FIG. 4B, the carriage end stop 110 may be rotated along a rotation axis 115. The rotation axis 115 is substantially perpendicular to the longitudinal opening 104. The carriage end stop 110 may be rotated until the second dimension 112 is perpendicular to the end opening 106. In some embodiments, the carriage end stop 110 may be tilted during rotation so a first end 121 and a second end 122 of the carriage end stop 110 do not interfere with the inner channel 102 during rotation. After rotation, the carriage end stop 110 may be returned to contact the first and second rail support flanges 107a and 107b.

As shown in FIG. 4C, the carriage end stop can be moved towards the longitudinal opening 104 along the direction shown by arrow A until the end stop rests against the first and second rail support flanges 107a and 107b.

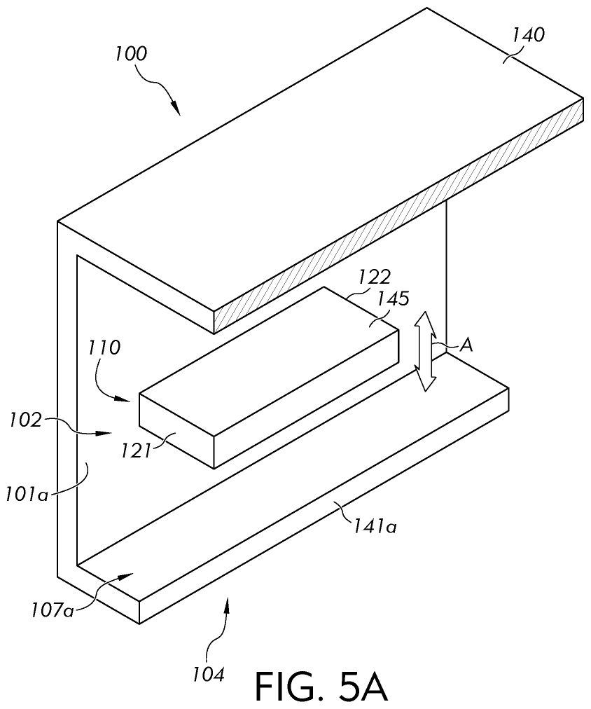

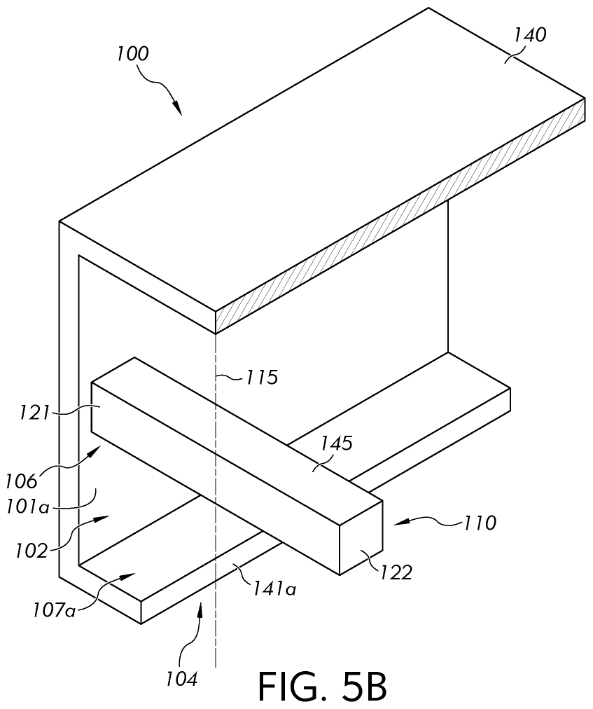

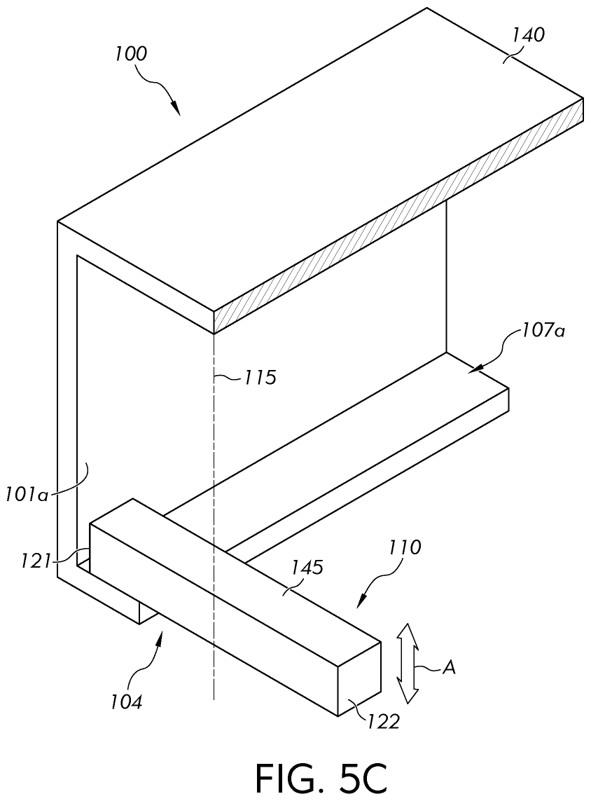

Referring now to FIGS. 5A, 5B, and 5C, the various methods of orientation of the carriage end stop 110 of FIGS. 2 and 3 are shown from a different perspective relative to FIGS. 4A-4C. The rail 100 is shown sectioned longitudinally along the center of the upper wall 140. As shown in FIG. 5A, the carriage end stop 110 is oriented in a way so as to allow it to pass through longitudinal opening 104. The carriage end stop 110 may be inserted into the inner channel 102 by moving the carriage end stop 110 toward the upper wall 140 along the direction shown by arrow A.

As shown in FIG. 5B, the carriage end stop 110 may be rotated along a rotation axis 115. The rotation axis 115 is perpendicular to the longitudinal opening 104. The carriage end stop 110 may be rotated until the second dimension 112 is perpendicular to the end opening 106. In some embodiments, the carriage end stop 110 may be tilted during rotation so the first end 121 and the second end 122 of the carriage end stop 110 do not interfere with the inner channel 102 during rotation. After rotation, the carriage end stop 110 may be returned to contact the first and second rail support flanges 107a and 107b (not shown).

As shown in FIG. 5C, the carriage end stop can be moved towards the longitudinal opening 104 along the direction shown by arrow A until the end stop rests against the first and second rail support flanges 107a and 107b (not shown).

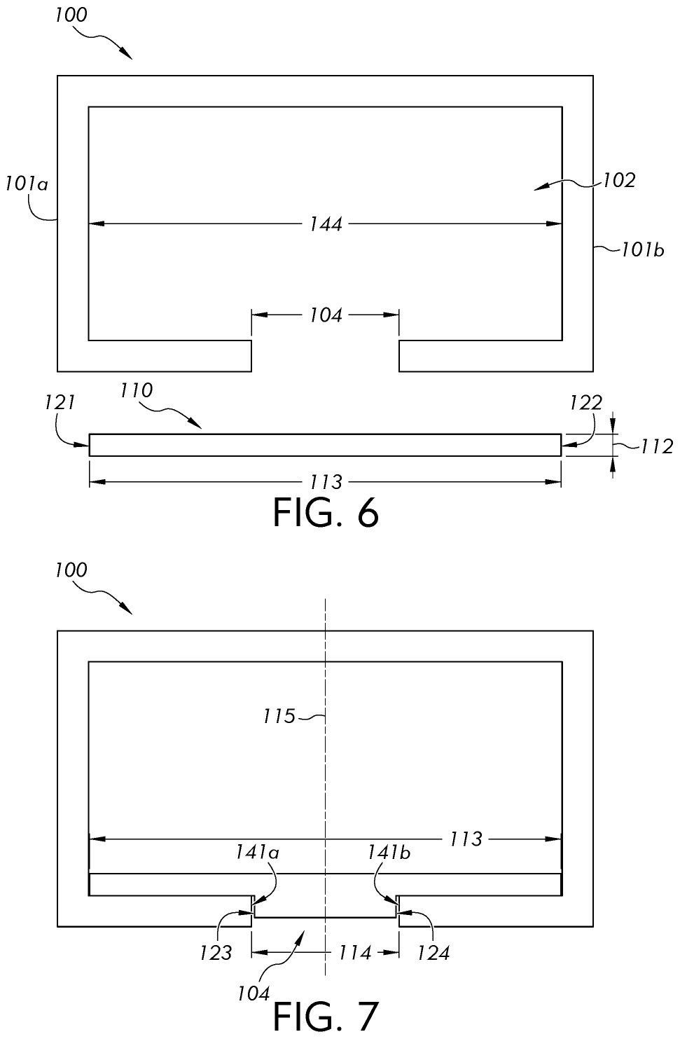

Referring now to FIG. 6, the first dimension 113 and the second dimension 112 of the carriage end stop 110 are shown. In some embodiments, the first dimension 113 of the carriage end stop 110 corresponds to the rail width 144. In one embodiment, the first dimension 113 of the carriage end stop 110 corresponds to the rail width 144 such that there is a small enough gap between the first end 121 of the carriage end stop 110 and the second end 122 of the carriage end stop 110 and the first wall 101a and the second wall 101b such that the carriage end stop 110 cannot be rotated around an axis perpendicular to the longitudinal opening 104 after the carriage end stop 110 has been installed. In another embodiment, the first dimension 113 of the carriage end stop 110 corresponds to the rail width 144 such that the first dimension 113 of the carriage end stop 110 is substantially equal to the rail width 144. In another embodiment, the first dimension 113 of the carriage end stop 110 corresponds to the rail width 144 such that the carriage end stop first dimension is greater than the rail width 144 such that the first wall 101a and the second wall 101b flexes as the carriage end stop 110 is installed.

Referring now to FIG. 7, a portion of the carriage end stop is disposed between the first end face 141a and the second end face 141b. A third face 123 of the carriage end stop 110 and a fourth face 124 of the carriage end stop 110 are shown. A third dimension 114 of the carriage end stop 110 includes the distance between the third face 123 and the fourth face 124. In some embodiments, the third dimension 114 of the carriage end stop 110 corresponds to the longitudinal opening 104. In one embodiment, the third dimension 114 of the carriage end stop 110 corresponds to the longitudinal opening 104 such that there is a small enough gap between the third face 123 and the fourth face 124 of the carriage end stop 110 and the first end face 141a and the second end face 141b such that the carriage end stop 110 cannot be rotated around an axis perpendicular to the longitudinal opening 104 after the carriage end stop 110 has been installed. In another embodiment, the third dimension 114 of the carriage end stop 110 corresponds to the longitudinal opening 104 such that the third dimension 114 of the carriage end stop 110 is equal to the longitudinal opening 104. In another embodiment, the third dimension 114 of the carriage end stop 110 corresponds to the longitudinal opening 104 such that the carriage end stop third dimension is greater than the longitudinal opening 104 such that the first end face 141a and the second end face 141b flexes as the carriage end stop 110 is installed.

Referring now to FIG. 8, an indentation 105 in the upper wall 140 of the rail 100 is shown. The indentation 105 can include a wall 142 which forms the indentation 105. The indentation 105 can be any number of shapes, including but not limited to irregularly-shaped, semi-circular, rectangular, a cylindrical bore, or any other suitable shape. The indentation 105 can be of any suitable depth, including, but not limited to, about 10% of the thickness of the upper wall 140, about 25% of the thickness of the upper wall 140, about 50% of the thickness of the upper wall 140, about 75% of the thickness of the upper wall 140, or any other value or range not stated herein. In some embodiments, the indentation 105 may be a bore through the entire thickness of the upper wall 140. The indentation 105 may be located at any location laterally along the rail 100, including but not limited to adjacent to the end opening 106. The indentation 105 receives the securement device 111 when the securement device 111 securably tensions the carriage end stop. The indentation 105 may make it more difficult to displace the carriage end stop 110 after the securement device 111 has been tensioned as the securement device 111 can be held in place by the wall 142 in addition to the securement device 111 being tensioned against the upper wall 140.

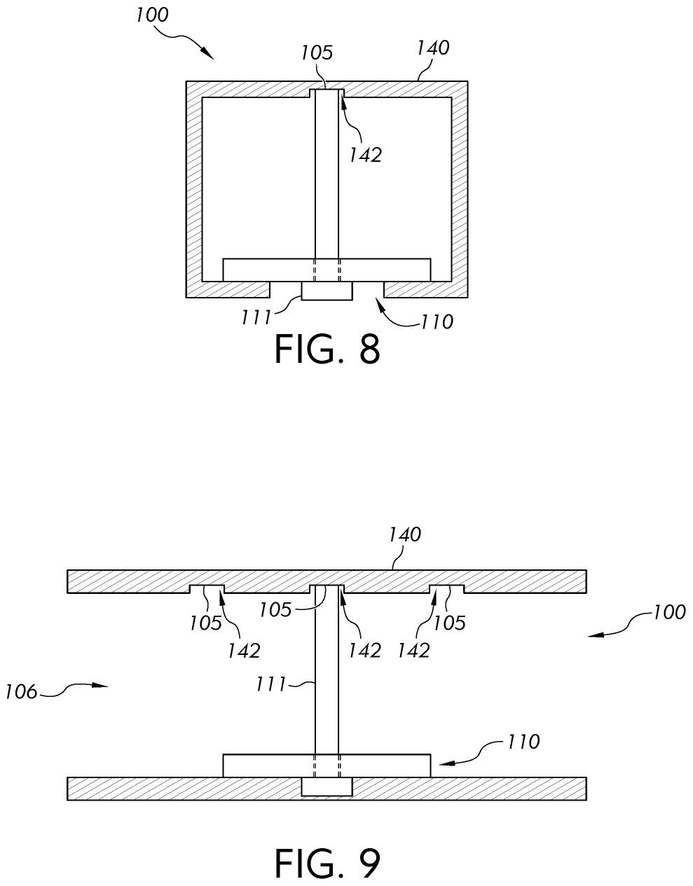

Referring now to FIG. 9, a plurality of indentations 105 in the upper wall 140 of the rail 100 are shown. It is to be noted that while three indentations are shown in this figure, any number of indentations can be used, including two indentations, four indentations, five indentations, or any number higher than five indentations. The plurality of indentations 105 may be spaced laterally along the rail 100. In some embodiments, the plurality of indentations 105 may be placed at a regular distance between indentations, such as five centimeters between indentations, ten centimeters between indentations, twenty centimeters between indentations, or any other suitable distance between indentations. The plurality of indentations 105 may also be placed at irregular distances between indentations such that there is a different distance between each indentation.

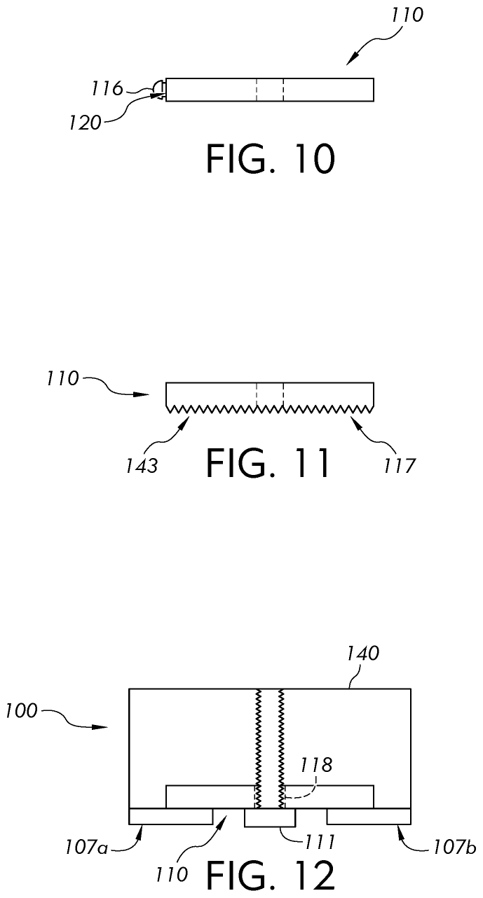

Referring now to FIG. 10, a bumper 116 is shown on the lateral surface 120 of the carriage end stop 110 such that the bumper 116 faces the carriage 103 (not shown). The bumper 116 can include any compliant material, including but not limited to foam, rubber, a combination of foam and rubber, or any other compliant material. As the carriage 103 travels laterally within the rail 100 the carriage may come in contact with the bumper 116 on the carriage end stop 110. The bumper 116 may deform as the carriage 103 contacts the bumper 116. The deformation of the bumper 116 may reduce the shock of the carriage 103 contacting the carriage end stop 110. The bumper 116 may further extend the time it takes the carriage 103 to come to a complete stop, which can reduce the forces on any features attached to the carriage 103. In another embodiment, the bumper 116 may be attached to the portion of the carriage 103 which comes into contact with the carriage end stop 110 (not shown). In yet another embodiment, there may be a plurality of bumpers 116 where at least one bumper 116 is attached to the lateral surface 120 of the carriage end stop 110 and at least one bumper 116 attached to the portion of the carriage 103 which comes into contact with the carriage end stop 110 (not shown).

Referring now to FIG. 11, a gripping surface 117 is shown on the lower face 143 of the carriage end stop 110. The gripping surface 117 may contact the first rail support flange 107a and the second rail support flange 107b. The gripping surface 117 may be different designs, including but not limited to a series of teeth, a series of grooves, a serrated surface, a mixture of these surfaces, or any other gripping surface or surface that provides increased friction to maintain a positioning of the carriage end stop 110. As the securement device 111 tensions the carriage end stop 110 against the first rail support flange 107a (not shown) and the second rail support flange 107b (not shown), the gripping surface 117 may contact the first rail support flange 107a and the second rail support flange 107b. As the gripping surface 117 contacts the first rail support flange 107a and the second rail support flange 107b, the carriage end stop 110 may be secured in such a way so that more force is necessary (relative to end stops without the gripping surface 117) in order to displace the carriage end stop 110 if the carriage 103 (not shown) comes into contact with the carriage end stop 110. As such, the gripping surface 117 may provide additional means of securing the carriage end stop 110 within the rail.

Referring now to FIG. 12, a securement device 111 is shown as a threaded bolt. Carriage end stop 110 includes a threaded bore 118 into which the securement device 111 can be threaded. The thread pattern on the securement device 111 should match the thread pattern of the threaded bore 118 such that the securement device 111 may be threaded into the threaded bore 118. The securement device 111 can be threaded until it comes into contact with the upper wall 140 of the rail 100. In some embodiments, a user may apply a downward force on the carriage end stop 110 directed towards the first and second rail support flanges 107a and 107b such that the frictional contact between the carriage end stop 110 and the first and second rail support flanges 107a and 107b prevents the carriage end stop 110 from rotating while the securement device 111 is threaded in the threaded bore 118. In another embodiment, the relative size of the carriage end stop 110 and the rail 100 may prevent the carriage end stop 110 from rotating while the securement device 111 is threaded in the threaded bore 118. As the securement device 111 is tensioned against the upper wall 140 of the rail 100, the carriage end stop 110 is drawn down the threads and toward the first and second rail support flanges 107a and 107b such that the carriage end stop 110 is held tightly against the first and second rail support flanges 107a and 107b.

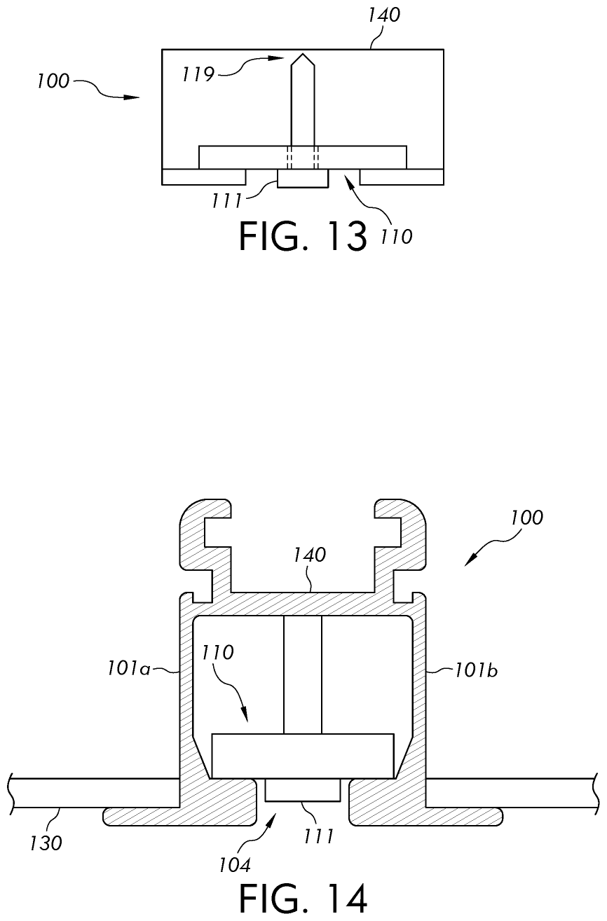

Referring now to FIG. 13, a securement device 111 is shown with a tapered end 119. The tapered end 119 can be a sloped or conical shape such that the securement device comes to a single line or a single point. The single line or point may be the line or point which comes into contact with the upper wall 140 of the rail 100. The small surface area of the single line or point of the securement device 111 can allow the securement device to dig into the upper wall 140 of the rail 100 by slightly deforming a portion of the upper wall 140 of the rail 100 as the securement device 111 is tensioned. This may secure the carriage end stop 110 in such a way so that more force is necessary (relative to securement devices 111 without a tapered end 119) in order to displace the carriage end stop 110 if the carriage 103 (not shown) comes into contact with the carriage end stop 110. As such, the tapered end 119 may provide additional means of securing the carriage end stop 110 within the rail.

Referring now to FIG. 14, a rail 100 with and carriage end stop 110 is shown embedded within a ceiling of a facility 130 (facility not shown). The facility may be for example a hospital room, an assisted living center, a physical therapy office, or any other facility where overhead rail and carriage systems may be used. The ceiling of the facility 130 may have a cutout which allows for a rail to be placed so that the bottom of the rail is visible and the bottom of the rail is even with the remainder of the ceiling of the facility. The longitudinal opening 104 may be exposed such that it is accessible when the rail 100 is embedded within the ceiling of the facility 130. Since the longitudinal opening 104 is still exposed, the carriage end stop 110 may be inserted, serviced, and removed from the rail 100 without needing to access the first wall 101a, the second wall 101b, or the upper wall 140 of the rail 100. Further, the carriage end stop 110 may be inserted, serviced, and removed from the rail 100 without needing to disassemble to ceiling of the facility 130.

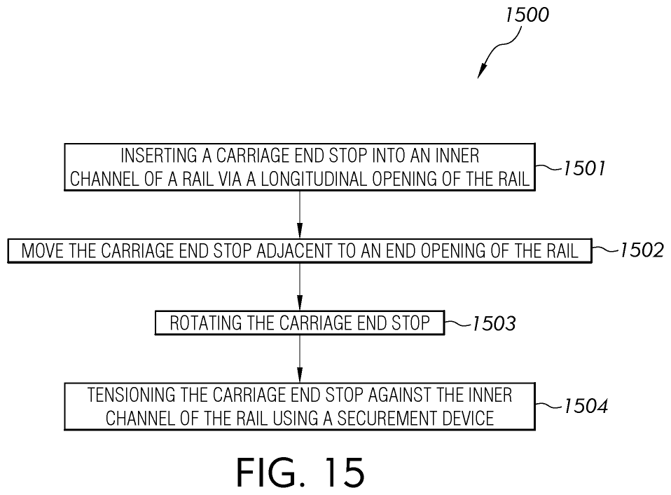

In some embodiments, the carriage end stop 110 and/or one or more of the various components described herein with respect to FIGS. 1-14 may be provided as a kit of parts for retrofitting an existing rail in or on a ceiling of a facility as described herein. That is, a kit of parts can be provided to include the various components described with respect to FIGS. 1-14, as well as one or more instructions for inserting the carriage end stop 110 within the inner channel 102 of the rail 100. The kit of parts may also include instructions for tensioning the carriage end stop against the inner surface of the rail 100. The instructions may be provided as a set of steps similar to the various blocks described hereinbelow with respect to the flow diagrams of FIGS. 15-17.

Referring now to FIG. 15, the steps of a method for providing a device for stopping a carriage 103 inside of a rail 100 is described. With reference also to FIGS. 1-7 at block 1501, the method 1500 includes inserting carriage end stop 110 into the inner channel 102 of the rail 100 via the longitudinal opening 104 in the rail 100. That is, the carriage end stop 110 is oriented with respect to the longitudinal opening 104 such that the first dimension 113 of the body 145 extends across the longitudinal opening 104 and the body 145 can be passed through the longitudinal opening 104 into the inner channel 102 of the rail 100. At block 1502, the method 1500 includes moving the carriage end stop 110 adjacent to the end opening 106 of the rail 100. The step of block 1502 may be combined with the step of block 1501 by inserting the carriage end stop 110 into the inner channel 102 of the rail 100 at a location adjacent to the end opening 106 of the rail 100. At block 1503, the method 1500 includes rotating the carriage end stop 110. The carriage end stop 110 may be rotated around the rotation axis 115 perpendicular to the longitudinal opening 104. The carriage end stop 110 may be rotated either clockwise or counter clockwise. The carriage end stop 110 may be rotated a sufficient angle such that there is a portion of the carriage end stop 110 that overhangs the first rail support flange 107a and the second rail support flange 107b. In some embodiments, the carriage end stop can be rotated 90 degrees. While FIG. 15 illustrates the step of block 1502 coming before the step of block 1503, it should be understood that the step of block 1502 may come before the step of block 1503. That is, the carriage end stop 110 may be rotated before the carriage end stop 110 is moved adjacent to the end opening 106 of the rail 100. At block 1504, the method 1500 includes tensioning the carriage end stop 110 against the inner channel 102 of the rail 100 using the securement device 111.

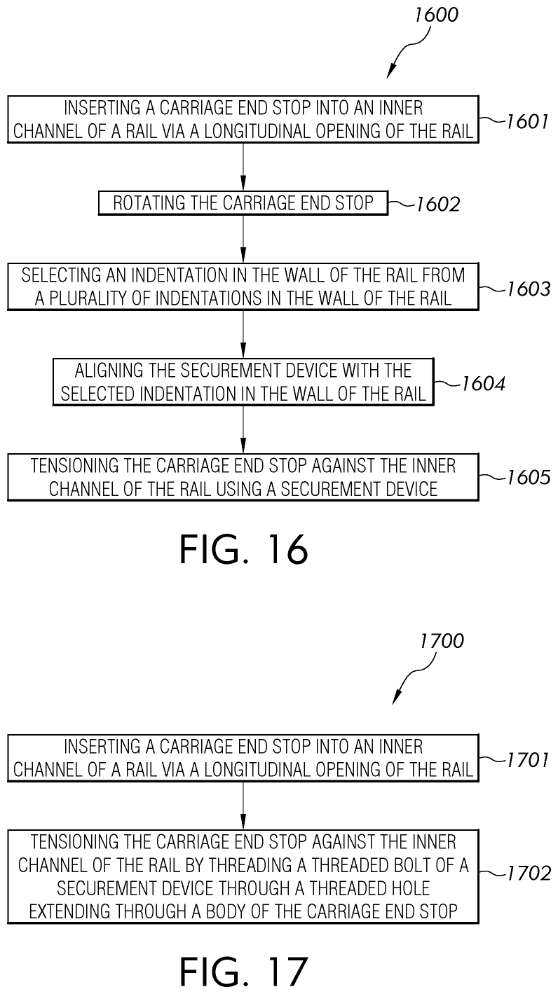

Referring now to FIG. 16, the steps of another method for providing a device for stopping a carriage 103 inside of a rail 100 is described. With reference also to FIGS. 8-9, the steps of method 1600 for stopping a carriage 103 inside of a rail 100 includes all of the steps as described in FIG. 15, and at block 1603 the method 1600 includes the step of selecting an indentation 105 in the upper wall 140 of the rail 100 from a plurality of indentations 105. In some embodiments, the selected indentation 105 may be adjacent to the end opening 106 which may include moving the carriage end stop 110 adjacent to the end opening 106. At block 1604 the method 1600 includes the step of aligning the securement device 111 with the selected indentation 105 in a wall of the rail before tensioning the carriage end stop 110 against the inner channel of the rail using the securement device. The indentation 105 may be formed in the upper wall 140 of the rail 100. Note that in some embodiments, there may be a single indentation 105 in the upper wall 140 of the rail 100. In this embodiment, the step of selecting an indentation 105 in the upper wall 140 of the rail 100 from a plurality of indentations 105 of block 1603 is omitted.

Referring now to FIG. 17, the steps of another method for providing a device for stopping a carriage 103 inside of a rail 100 is described. With reference also to FIG. 12, the steps of method 1700 for stopping a carriage 103 inside of a rail 100 includes the step at block 1701 of includes inserting carriage end stop 110 into the inner channel 102 of the rail 100 via the longitudinal opening 104 in the rail 100. That is, the carriage end stop 110 is oriented with respect to the longitudinal opening 104 such that the first dimension 113 of the body 145 extends across the longitudinal opening 104 and the body 145 can be passed through the longitudinal opening 104 into the inner channel 102 of the rail 100. At block 1702, the method 1700 includes the step of tensioning the carriage end stop 110 against the inner channel 102 of the rail 100 using the securement device 111 by threading a threaded securement device 111 through a threaded bore 118 in the carriage end stop 110.

Further aspects of the present disclosure are provided by the subject matter of the following clauses:

An overhead lift system, comprising: a rail having at least one wall that defines an inner channel shaped and sized to guide movement of a carriage within the inner channel, the at least one wall further defining a longitudinal opening into the inner channel, the longitudinal opening extending along a length of the rail and having a width, a carriage end stop having a body shaped and sized to correspond to the inner channel such that the body is insertable within the inner channel, and a securement device securably tensioning the carriage end stop against the at least one wall of the rail to prevent movement of the carriage end stop within the inner channel.

The system according to any previous clause, wherein the rail comprises at least one end opening.

The system according to any previous clause, wherein the body of the end stop defines a first dimension that is less than the width of the longitudinal opening and a second dimension that is greater than the width of the longitudinal opening.

The system according to any previous clause wherein: the at least one wall comprises a first rail wall and a second rail wall opposite and separated from one another by a rail width, and the body of the carriage end stop has a body width that corresponds in size to the rail width.

The system according to any previous clause, wherein: the rail comprises a first support flange end face and a second support flange end face opposite and separated from one another by a support flange width, and a portion of the body of the carriage end stop has a body width that corresponds in size to the support flange width.

The system according to any previous clause, further comprising: an indentation disposed in an upper wall of the at least one wall at a location opposite the longitudinal opening, wherein the indentation receives the securement device when the securement device securably tensions the carriage end stop against the at least one wall of the inner channel.

The system according to any previous clause, wherein the indentation is a cylindrical bore.

The system according to any previous clause, further comprising: a plurality of indentations disposed in an upper wall of the at least one wall and spaced apart from each other at locations opposite the longitudinal opening, wherein each one of the plurality of indentations receives the securement device when the securement device securably tensions the carriage end stop against the at least one wall of the inner channel.

The system according to any previous clause, wherein the plurality of indentations are cylindrical bores extending at least partially through the upper wall.

The system according to any previous clause, further comprising: a bumper disposed on a lateral surface of the body of the carriage end stop.

The system according to any previous clause, wherein at least one surface of the body of the carriage end stop comprises a gripping surface.

The system according to any previous clause, wherein the securement device is a threaded bolt and the body of the carriage end stop defines a threaded bore that receives the threaded bolt.

The system according to any previous clause, wherein the securement device has a tapered end.

The system according to any previous clause, wherein the rail is at least partially embedded within a ceiling of a facility.

A device for an overhead lift system, the device comprising: a carriage end stop comprising a body shaped and sized to correspond to an inner channel of a rail such that the body is insertable within the inner channel of the rail and movable in a longitudinal direction along the inner channel of the rail, wherein a first dimension of the body is less than a width of a longitudinal opening of the rail and a second dimension of the body is greater than the width of the longitudinal opening of the rail, and a securement device coupled to the body and extending from the body, the securement device movable to force the body against an inner surface of the rail and hold the body in place within the channel of the rail.

The device according to any previous clause, further comprising a bumper disposed on a lateral surface of the body.

The device according to any previous clause, wherein at least one surface of the body comprises a gripping surface.

The device according to any previous clause, wherein the securement device is a threaded bolt and the body of the carriage end stop defines a threaded bore that receives the threaded bolt.

The device according to any previous clause, wherein the securement device has a tapered end.

A kit of parts, comprising: the device according to any previous clause and one or more instructions for inserting the carriage end stop within the channel of the rail.

The kit of parts according to any previous clause, further comprising one or more instructions for tensioning the carriage end stop against the inner surface of the rail.

A method for installing a device for stopping a carriage inside of a rail having at least one end opening, the method comprising: inserting a carriage end stop into an inner channel of the rail via a longitudinal opening in a wall of the rail, wherein the carriage end stop is sized to correspond to the inner channel, and tensioning the carriage end stop against the inner channel of the rail using a securement device.

The method of any previous clause, further comprising: rotating the carriage end stop after inserting the carriage end stop into the inner channel of the rail.

The method of any previous clause, further comprising: prior to tensioning the carriage end stop, moving the carriage end stop adjacent to the end opening of the rail.

The method of any previous clause, further comprising: aligning the securement device with an indentation in a wall of the rail, and tensioning the securement device at least partially inside the indentation.

The method of any previous clause, further comprising: prior to aligning the securement device, selecting an indentation from among a plurality of indentations.

The method of any previous clause, wherein tensioning the securement device inside the inner channel comprises threading a threaded bolt of the securement device through a threaded hole extending through a body of the carriage end stop.

What is claimed is:

1. An overhead lift system, comprising:
a rail having at least one wall that defines an inner channel shaped and sized to guide movement of a carriage within the inner channel, the at least one wall further defining a longitudinal opening into the inner channel, the longitudinal opening extending along a length of the rail and having a width;
a carriage end stop having a body shaped and sized to correspond to the inner channel such that the body is insertable within the inner channel; and
a securement device securably tensioning the carriage end stop against the at least one wall of the rail to prevent movement of the carriage end stop within the inner channel.

2. The overhead lift system according to claim 1, wherein the rail comprises at least one end opening.

3. The overhead lift system according to claim 2, wherein the body of the carriage end stop defines a first dimension that is less than the width of the longitudinal opening and a second dimension that is greater than the width of the longitudinal opening.

4. The overhead lift system according to claim 1, further comprising:
an indentation disposed in an upper wall of the at least one wall at a location opposite the longitudinal opening, wherein the indentation receives the securement device when the securement device securably tensions the carriage end stop against the at least one wall of the inner channel.

5. The overhead lift system according to claim 1, further comprising:
a plurality of indentations disposed in an upper wall of the at least one wall and spaced apart from each other at locations opposite the longitudinal opening, wherein each one of the plurality of indentations receives the securement device when the securement device securably tensions the carriage end stop against the at least one wall of the inner channel.

6. The overhead lift system according to claim 1, wherein:
the at least one wall comprises a first rail wall and a second rail wall opposite and separated from one another by a rail width; and
the body of the carriage end stop has a body width that corresponds in size to the rail width.

7. The overhead lift system according to claim 1, wherein:
the rail comprises a first support flange end face and a second support flange end face opposite and separated from one another by a support flange width; and
a portion of the body of the carriage end stop has a body width that corresponds in size to the support flange width.

8. The overhead lift system according to claim 1, further comprising:
a bumper disposed on a lateral surface of the body of the carriage end stop.

9. The overhead lift system according to claim 1, wherein at least one surface of the body of the carriage end stop comprises a gripping surface.

10. The overhead lift system according to claim 1, wherein the securement device is a threaded bolt and the body of the carriage end stop defines a threaded bore that receives the threaded bolt.

11. The overhead lift system according to claim 1, wherein the securement device has a tapered end.

12. The overhead lift system according to claim 1, wherein the rail is at least partially embedded within a ceiling of a facility.

13. A device for an overhead lift system, the device comprising:
a carriage end stop comprising a body shaped and sized to correspond to an inner channel of a rail such that the body is insertable within the inner channel of the rail and movable in a longitudinal direction along the inner channel of the rail, wherein a first dimension of the body is less than a width of a longitudinal opening of the rail and a second dimension of the body is greater than the width of the longitudinal opening of the rail; and
a securement device coupled to the body and extending from the body, the securement device movable to force the body against an inner surface of the rail and hold the body in place within the inner channel of the rail.

14. The device according to claim 13, further comprising a bumper disposed on a lateral surface of the body.

15. The device according to claim 13, wherein at least one surface of the body comprises a gripping surface.

16. The device according to claim 13, wherein the securement device is a threaded bolt and the body of the carriage end stop defines a threaded bore that receives the threaded bolt.

17. The device according to claim 13, wherein the securement device has a tapered end.

18. A method for installing a device for stopping a carriage inside of a rail, the method comprising:
inserting a carriage end stop into an inner channel of the rail via a longitudinal opening in a wall of the rail, wherein the carriage end stop is sized to correspond to the inner channel; and
tensioning the carriage end stop against the inner channel of the rail using a securement device.

19. The method according to claim 18, further comprising:
rotating the carriage end stop after inserting the carriage end stop into the inner channel of the rail.

20. The method according to claim 18, further comprising:
aligning the securement device with an indentation in the wall of the rail; and
tensioning the securement device at least partially inside the indentation.
